(19) United States
(12) Patent Application Publication
(10) Pub. No.: US 2013/0091447 A1
(43) Pub. Date: Apr. 11, 2013

(54) CONTENT CONTROL METHOD AND SYSTEM FOR OPTIMIZING INFORMATION ON DISPLAY SCREEN OF MOBILE DEVICE

(71) Applicant: Ki Dong Kang, Seoul (KR)

(72) Inventor: Ki Dong Kang, Seoul (KR)

(73) Assignees: KIA MOTORS CORPORATION, Seoul (KR); HYUNDAI MOTOR COMPANY, Seoul (KR)

(21) Appl. No.: 13/339,982

(22) Filed: Dec. 29, 2011

(30) Foreign Application Priority Data
Oct. 5, 2011 (KR) 10-2011-0101214

(51) Int. Cl. G06F 3/048

(52) U.S. Cl. 715/764

(57) ABSTRACT

Content control method and system for optimizing information on a display screen of a mobile device which preferentially arranges a primarily optimized layout among content to be displayed on a screen and outputs detailed content in a corresponding area on the screen in phases when there is a touch input (for expanding a specific area of the screen by a user. In particular, when a touch input of a first pattern input through a touch screen is recognized, content related to the touched area is expanded by a predetermined ratio and the expanded content is displayed on a screen. Simultaneously, detailed information of the content selected by the touch input of the first pattern is read from the memory and the read detailed information is output on the touch screen.

### CROSS-REFERENCES TO RELATED APPLICATIONS

The priority of Korean patent application No. 10-2011-0101214 filed on Oct. 5, 2011, the disclosure of which is hereby incorporated in its entirety by reference, is claimed.

### BACKGROUND OF THE INVENTION

1. Field of the Invention

The present invention relates to content control method and system for optimizing information on a display screen of a mobile device including a touch screed. More particularly, the present invention relates to content control method and system for optimizing information on a display screen of a mobile device which preferentially arranges a primarily optimized layout among contents to be displayed on a screen and outputs detailed contents in a corresponding area on the screen in phases when there is, e.g., a touch input (such as a dynamic pinch/spread) for expanding a specific area of the screen by a user, considering characteristics of a mobile device with limitation of the number of contents to be outputted to one screen due to a small size.

2. Description of the Related Art

Generally, with development of technology, mobile terminals have become lighter, thinner, simpler and smaller in appearance and have been developed to perform various multimedia functions such as imaging a still image or a moving image, reproducing music or an image file, or gaming in addition to conventionally basic functions such as a broadcast reception apparatus or a communication apparatus, in response to increased user demand. As a result, information which should be transmitted to the user by the mobile devices has become increased and diversified. However, display devices which functions to output the information on a screen have limitations in thickness and size.

In particular, since convenience for carrying is preferentially prerequisite to the mobile devices, the body size of the mobile device is necessarily restricted and thus the display device has a limited body size. Accordingly, when a plurality of contents (for example, persons, documents, programs, applications, navigation, etc.) are displayed on a display screen of a mobile device in the related art, only information representative of a corresponding content is displayed due to the limitation of a size of a display area, and a function to conform sub information included in each content at a time is not provided. In addition, even when the function is provided, the function does not actually help to the user due to the need for complicated setting operations and thus there is a need for a method for improving the problem.

Furthermore, when the plurality of content is simultaneously displayed on one screen, any one of the plurality of contents may be selected and an information reading mode is executed. Thereby, it is possible to confirm a plurality of sub information included in the selected content. However, when the information reading mode is executed, the non-selected contents are not displayed on the screen any more.

For example, when navigation content, video content, and weather content are simultaneously displayed on the screen and a user intends to confirm details of the weather content among the contents, it is possible to confirm the detailed sub information on the weather content by selecting the weather content and executing the information reading mode. However, due to the execution of the information reading mode, since there is not enough space to display weather content as well as the navigation content and video content, only the weather content is displayed and thus the navigation content and video content cannot be displayed. Accordingly, it is difficult to confirm representative information on various contents besides the content selected by the user.

### SUMMARY OF THE INVENTION

Various aspects of the present invention have been made in view of the above problems, and provide content control method and system for optimizing information on a display screen of a mobile device which preferentially arranges a primarily optimized layout among contents to be displayed on a screen and outputs detailed contents in a corresponding area on the screen in phases when there is a touch input (e.g., a dynamic pinch/spread) for enlarging a specific area of the screen by a user, considering characteristics of a mobile device with limitation of the number of contents to be outputted to one screen due to a small size.

According to an aspect of the present invention, a content control system for optimizing information on a display screen of a mobile device including a touch screen is provided. The system may include: a memory configured to store contents to be displayed on a touch screen as data; a control unit configured to control an overall operation of the device according to a user's touch input through the touch screen; and a touch interaction module configured to analyze the user's touch input through the touch screen and to recognize a control command corresponding to the user's touch input. In particular, when a touch input of a first pattern is recognized by the control unit through the touch interaction module, the control unit controls the content of an area to which the touch input is applied to expand and outputs by a preset rate. Simultaneously, detailed information of the content of the area is read and displayed on a screen with the expanded content.

The memory may be a content division storage unit in which sub information including detailed information on each of one or more contents output through the touch screen is divided into multiple steps as a hierarchical structure and managed.

The touch interaction module may be implemented in the control unit. When the touch input of the first pattern is consecutively sensed through the touch interaction module, the control unit may output the sub information of the hierarchical structure step by step at each time of point that the touch input is sensed. When a touch input of a second pattern is sensed through the touch interaction module, the control unit may downscale and display the content of a corresponding area at a predetermined ratio step by step and simultaneously the control unit may erase sub information of a hierarchical structure on a screen at each time that the touch input of the second pattern is sensed.

According to still another aspect of the present invention, a content control method for optimizing information on a display screen of a mobile device including a memory configured to store contents to be output through a touch screen as data and a control unit configured to control the device is provided. The method may include: recognizing a touch input of a first pattern input through the touch screen; and expanding a content of an area to which the touch input of the first pattern is input at a predetermined ratio and displaying the expanded content on a screen, and simultaneously reading detailed information of the content selected by the touch input of the first pattern from the memory and outputting read detailed information.

Information of the content stored in the memory may be implemented with a plurality of hierarchical structures having detailed contents step by step. When the touch input of the first pattern is consecutively sensed in the recognizing the touch input, the control unit may read sub information from the memory step by step and sequentially execute the expanding the content and outputting the detailed information based on the read sub information at each time of point that the touch input of the first pattern is sensed.

Recognizing the touch input may further include recognizing a touch input of a second pattern input through the touch screen. When the touch input of the second pattern is sensed, the control unit may downscale content of a corresponding area by a predetermined ratio and output the downscaled content on the screen. Simultaneously, the control unit may erase sub information of the content selected by the touch input of the second pattern step by step at each point in time that the touch input of the second pattern is sensed.

The touch input of the first pattern may be defined as an input type, in which a first point and a second point on a content displayed on the touch screen are multi-touched. The distance between the first and second points may be spaced away from each other in a way to exceed a predetermined distance.

The touch input of the second pattern may be defined as an input type, in which a first point and a second point on a content displayed on the touch screen are multi-touched. Again, the distance between the first and second points may approach to be narrow within a predetermined distance. The touch input of the second pattern may be implemented with any one selected from the group consisting of a long touch, a proximity touch, a long proximity touch, and a double touch.

According to the above exemplary embodiments of the present invention, when the user executes the screen enlargement for the special area through the previously predetermined touch input under the plurality of contents displayed on the screen, the detailed information of the selected contents and the representative information of other contents is provided to the user while the contents which the user wants to confirm is enlarged at a rate, maintaining the plurality of contents displayed on the screen.

As a result, the subordinate information of the contents selected by the user can be automatically outputted on the enlarged screen without any special additional input, thereby allowing the user to easily confirm the subordinate information included in the contents. In addition, the display screen with the limited size is effectively optimized by providing the function of downsizing the enlarged contents at the original rate through the predetermined input.

The systems and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a mobile device provided with a content control function for optimizing a screen output according to an exemplary embodiment of the present invention.

FIG. 2 is a view illustrating an outward appearance of a mobile device having the configuration of FIG. 1.

FIG. 3 is a view illustrating an example of a user's operation and a screen output.

FIG. 4 is a flow chart illustrating an operation of a mobile device provided with a content control function for optimizing a screen output according to an exemplary of the present invention.

FIGS. 5A to 5B are views illustrating processes of expanding a screen and displaying the sub information of a selected content according to an exemplary embodiment of the present invention.

FIGS. 6A to 6E are views illustrating processes of exhibiting sub content though a screen expansion and erasing of the sub content through a screen reduction according to an exemplary embodiment of the present invention.

FIG. 7 is a view illustrating a process of selecting sub information display target through setting a menu according to an exemplary embodiment of the invention.

FIGS. 8A to 8B are views illustrating a processes of assigning a visual effect in a process of expanding a selected content according to an exemplary embodiment of the present invention.

FIGS. 9A and 9B are views illustrating an example for executing touch input of a second pattern by a double touch input method according to another exemplary embodiment of the present invention.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It should be understood that in a detail description below, as suffixes for configuration elements, ‘module’ and ‘unit’ are assigned or used together, for clarity, but there is no distinctive meaning or function between them per se.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

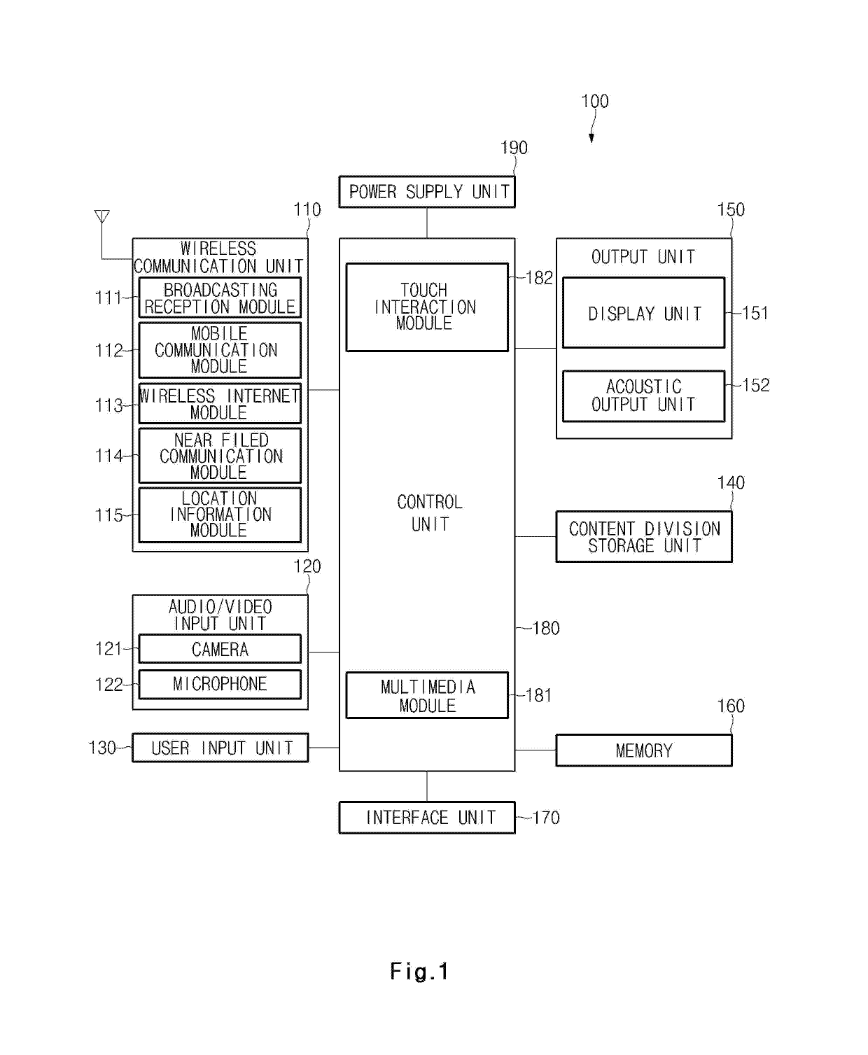

FIG. 1 is a block diagram illustrating a configuration of a mobile device provided with a content control function for optimizing screen output according to an exemplary embodiment of the present invention.

Even though the exemplary embodiment of the present invention has been illustrated that the mobile device is applied to a navigation apparatus for vehicles, it is just one example. The mobile device may be a terminal which is mounted on a vehicle or a terminal which is portable or installed in another available device depending on user's convenience. The mobile device may be implemented with various types of a mobile phone, a smart phone, a laptop computer, a digital broadcast reception terminal, a personal digital assistant (PDA), a portable multimedia player (PMP), a tablet computer, etc.

As shown in FIG. 1, the mobile device according to an exemplary embodiment of the present invention includes a wireless communication unit 110, an audio/video (A/V) input unit 120, a user input unit 130, an output unit 150, a memory 160, an interface unit 170, a control unit 180, and a power supply unit 190.

The wireless communication unit 110 may include at least one module that is configured to communicate wireless communications between the mobile device 100 and a wireless communication system, or between the mobile device 100 and a network provided in an area in which the mobile device 100 is located. That is, for example, the wireless communication unit 110 may include a broadcasting reception module 111, a mobile communication module 112, a wireless Internet module 113, a near field communication module 114, and a location information module 115, etc.

The broadcasting reception module 111 receives a broadcast signal via an antenna or receives broadcast-related information from an external broadcast management server via a broadcast channel. The broadcast channel may include satellite channels or terrestrial channels, as an example.

Meanwhile, the broadcast management server generates a broadcast signal and/or broadcast-related information and transmits the generated signal and/or information to the mobile device or receives a pre-generated broadcast signal and/or a pre-generated broadcast-related information and then transmits the received signal and/or information to the mobile device. In addition, the broadcast signal may include a broadcast signal in which the data broadcast signal is combined with a television (TV) broadcast signal or a radio broadcast signal as well as a data broadcast signal such as the TV broadcast signal, the radio broadcast signal, traffic information (for example, transport protocol experts group (TPEG) information).

The broadcast-related information may include broadcast channels, broadcast programs or information related to a broadcast service provider. The broadcast-related information may be received by the mobile communication module 112 through a mobile network, or provided in Internet protocol (IP) content formats through the wireless Internet module 113.

The broadcast-related information may exist in various formats. The digital broadcast signal may be received using a digital broadcast system such as electronic program guide (EPG) of digital multimedia broadcast (DMB), digital video broadcast-terrestrial (DVB-T), digital multimedia broadcast-satellite (DMB-S), media forward link only (MediaFLO), digital video broadcast-handheld (DMB-H), Integrated services digital broadcast-terrestrial (ISDB-T). The broadcast reception module 111 may include the above-described digital broadcast system. If necessary, the broadcasting reception module 111 may be configured to be suitable for other broadcast systems of different formats, which are not described above, including analog broadcasting.

The broadcast signal and/or broadcast-related information received through the broadcasting-reception module 111 may be stored in the memory 160 if necessary.

The mobile communication module 112 receives or transmits a radio signal from or to at least one of a base station, an external terminal, and a server on a mobile communication network. The radio signal may include data of various types according to message transmission/reception of a sound signal, an image communication signal, or text/multimedia message.

The wireless Internet module 113 is configured for wireless Internet connection. The wireless Internet module 113 may be built in the mobile device 100 or combined with the mobile device 100 in an armoured type. Wireless local area network (WLAN), (Wi-Fi), wireless broadband (Wibro), world interoperability for microwave access (Wimax), high speed downlink packet access (HSDPA) and etc. may be used as wireless Internet technology.

The near field communication module 114 is configured to perform short-range communication. As the near field communication module 114, Bluetooth, radio frequency identification (RFID), infrared data association (IrDA), ultra wideband (UWB), ZigBee, etc. may be used.

The location information module 115 is configured to obtain location information of the mobile device 100. For example, a global position system (GPS) is typically used. A current location may be calculated by integrally computing data received from the location information module 115. The current location may be displayed on a map through a display unit 151 to be described later. Guidance for a driving direction, a driving speed, and a route may be executed using the current location.

The A/V input unit 120 of FIG. 1 is configured to receive video information and audio information, and may include a camera 121, a microphone 122, etc. The camera 121 generates an image frame, such as a still image or a moving image, which is obtained by an image sensor in a black box recording mode for vehicles. The generated image frame may be displayed on the display unit 151.

Meanwhile, the image frame generated from the camera 121 may be stored in the memory 160 or transmitted to the outside through the wireless communication unit 110. Two or more cameras 121 may be provided according to the use environments, for example, to perform a multi-channel black box function for shooting images in two directions or more, e.g., forward and rearward directions, at the same time.

The microphone 122 is configured to receive external acoustic information in a communication mode, a record mode or a sound recognition mode, etc., and converts the received external acoustic information into an electronic sound signal. When in the communication mode, the converted sound signal may be processed into a transmittable form to the mobile communication base station by the mobile communication module 112 and output through the antenna. A user may directly input a destination or a starting point through voice commands to search a course. The microphone 122 may be implemented with various noise removal algorithms to remove noise generated during receiving the external acoustic signal.

The user input unit 130 is configured to generate input information for controlling an overall operation of the mobile device according to a user's operation. The user input unit 130 may include a key pad, a dome switch, a touch pad (static pressure/static electricity), a jog wheel, a jog switch, etc.

The output unit 150 is configured to display a result as a signal recognizable by a user through his/her own five senses through signal processing contracted by the mobile device 100. The output unit 150 includes a display unit 151 and an acoustic output module 152 which are representative output devices.

The display unit 151 displays the data processed by the mobile device 100 on the screen as visual information. For example, when the mobile device is in the navigation mode, the display unit 151 displays information for the current location, destination, a course etc., a map, a speed, a direction, a distance instruction, etc. on the screen, and provides a user interface (UI) related to these. When the mobile device is in the black box mode or the imaging mode, the display unit 151 provides an image or a user interface (UI) (or graphic user interface (GUI).

Meanwhile, the display unit 151 may include at least one of a liquid crystal display (LCD), a thin film transistor-liquid crystal display (TFT-LCD), an organic light emitting diode (OLED), a flexible display, a three dimensional (3-D) display, a dual play in which different images are displayed according to a view direction (for example, an output device in which a map is displayed when one display is viewed at a driver seat, and a broadcast image is displayed when the one display is viewed at a passenger seat).

Some of the above-described various display devices may be embodied as transparent or a light transmissive. A transparent organic light emitting diode (TOLED) is typically used as the display device. The rear side of the display unit 151, that is, a rearward structure, may be embodied as a light transmission type display unit. By such a structure, the user can view an object placed behind the body of the mobile device through an area in which the display unit 151 of the body of the mobile device is occupied.

In addition, two or more display units 151 may be disposed according to an embodied type of the mobile device 100. For example, a plurality of display devices may be arranged to be spaced apart from each other on one surface, or may be integrally disposed. The plurality of display devices may be separately arranged on different surfaces. When the display unit 151 has a sensor (hereinafter, referred to as a ‘touch sensor’), which senses a touch operation of the user have a layered structure, the display unit 151 can be used as an input device other than an output device. For example, the touch sensor may have various types such as a touch film, a touch sheet, or a touch pad.

The touch sensor is configured to convert a change of a pressure or a static capacitance applied to a special area of the display unit 151 into an electronic input signal. The touch sensor is configured to detect the pressure at a touch as well as a touched location and a touched area. When there is a touch input to the touch sensor, a signal corresponding to contact is generated and transmitted to a touch controller (not shown). The touch controller transmits data in which the signal is processed to the control unit 180. Thereby, the control unit 180 recognizes which area of a display panel is touched.

Hereinafter, for clarity, an action of recognizing a state in which a pointer is located on the touch screen while the pointer is not directly contacted with the touch screen and approaches the touch screen, is referred to as a “proximity touch”, and an action in which the pointer is in substantial contact with the touch screen, is referred to as a ‘contact touch’. On the touch screen, the location becoming the proximity touch with the pointer is designated as a location at which the pointer is perpendicular to the touch screen when the pointer approaches the touch screen. In addition, the touch screen may sense touch signals simultaneously applied to two or more points, and this is referred to as a ‘multi-touch’.

Meanwhile, the acoustic output module 152, in a multimedia file playback mode, a broadcast receiving mode, etc., may output the audio data, received from the wireless communication unit 110 or stored in the memory 160. The acoustic output module 152 outputs acoustic information related to a function, which is performed in the mobile device 100 (such as, an alarm sound, a notification sound, a course guidance sound, etc.). The acoustic output module 152 may include a receiver, a speaker, a buzzer, etc.

The memory 160 stores a program (e.g., a computer readable medium) to process the data of the control unit 180 and to control the control unit 180, retain content material such as telephone directory, map information, audio and video information as data, and temporarily store data which is input or output through the user input unit 130 or an output unit 150. The memory 160 may also store use frequency for each data (such as frequent destination, or use frequency to each multimedia file). The memory 160 may also store data related to vibrations and sounds of various patterns, which are output when a touch input is input on the touch screen.

The memory 160 may include any one type of storage mediums of either a flash memory type, a hard disk type, a multimedia card micro type, a card type such as a secure digital (SD) card or an extreme digital (XD), a random access memory (RAM), a static random access memory (SRAM), a read only memory (ROM), an electrically erasable programmable read only memory (EEPROM), a programmable read only memory (PROM), a magnetic disk, and light disk. Meanwhile, the mobile device 100 may be configured to interwork with the web storage executing a data storage function of the memory 160 on Internet.

The interface unit 170 performs a channel function to all external devices connected with the mobile device 100. The interface unit 170 receives data or power from the external devices and transmits the received data or power to each component in the mobile device 100. The interface unit 170 functions to transmit the processed data in the mobile device 100 to the external devices. The interface unit 170 may include a wired/wireless headset port, an external charger port, a wired/wireless data port, a video input/output (I/O) port, an earphone port, etc.

When the mobile device 100 is connected with an external cradle, the interface unit 170 may function as a channel through which the power supplied from the cradle is supplied to the mobile device 100 or through which various commands inputted from the cradle are transmitted to the mobile device 100. The various commands or the power may be used as an indicator to recognize a state in which the mobile device 100 is precisely installed to the cradle.

The control unit 180 is configured to control an overall operation of the mobile device 100. The control unit 180 performs control for data communication, course detection, black box recording, etc. and data processing. The control unit 180 includes a multimedia module 181 for multimedia reproduction. In addition, the control unit 180 includes a touch interaction module 182 to analyze a signal inputted through the touch sensor according to the predetermined criterion and to convert the analyzed signal into the corresponding commands.

In the FIG. 1, the reference numeral 180 denotes a content division storage unit that divides the contents to be displayed through the display unit 151 into main information and sub information and stored the main information and the sub information under control of the control unit 180. As shown in FIG. 1, the content division storage unit 140 may be separately configured with the memory 160, but the content division storage unit 140 may be implemented in the memory 160 if necessary. Alternatively, the control unit 180 may be configured to optionally access the content information stored in the memory 160 and to divide the selected content information into multiple stage and output the divided content information step by step without the special division storage module.

The multimedia module 181 and the touch interaction module 182 may not be necessarily implemented within the control unit 180. The multimedia module 181 and the touch interaction module 182 may be implemented separately from the control unit 180.

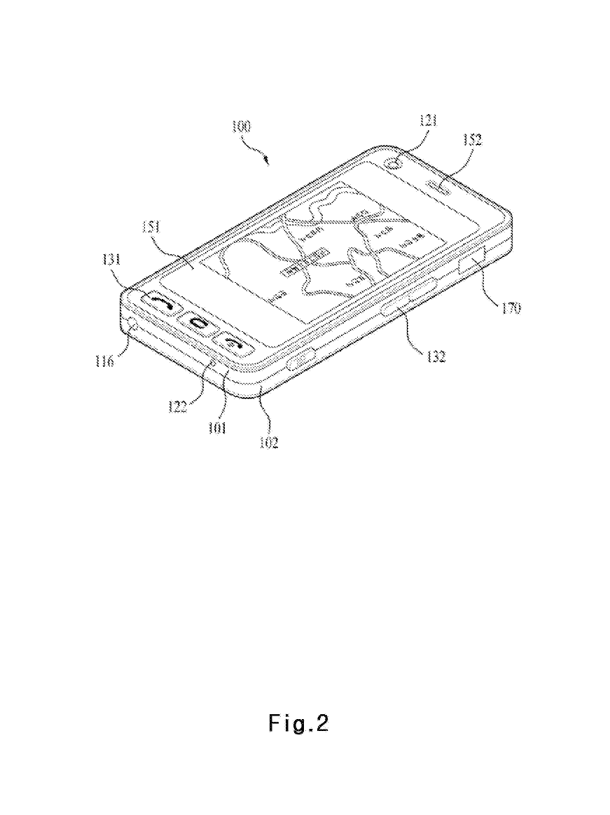

The power supply unit 190 supplies operation power to the whole of the device under control of the control unit 180. FIG. 2 is a view illustrating an outward appearance of the mobile device 100 having the configuration of FIG. 1. Even though the mobile device provided with a “bar shaped body” is illustrated in FIG. 1, other various structures such as a slide type, a folder type, a swing type, a swing ball type and etc. in which two or more bodies are combined may be applied thereto. The body of the mobile device may include a case (casing, housing, and cover etc.) making an outward appearance. The case may be made of plastic resin by an injection moulding method or may be made of, for example, metal materials such as stainless steel (STS) or titanium (Ti).

The display unit 151, the acoustic output unit 152, the camera 121, the user input unit 130, the microphone 122, the interface unit 170, etc. may be disposed in the body of the mobile device 100. The display unit 151 occupies most of a main surface, that is, a front surface of a front case. The acoustic output module 152 and the camera 121 are disposed within the upper portion of the display unit 151, and the input button 131 and the microphone 122 are disposed within the lower portion of the display unit 151. Other input device of the user input unit 130 and the interface unit 170, etc. may be disposed at a lateral surface of the front case and/or a rear case.

The user input unit 130 is configured to receive command for controlling an operation of the mobile device 100 from the user. The user input unit 130 may include a plurality of manipulation units. The plurality of manipulation units are generally called as a manipulation portion. Any tactile manner, however, may be employed.

The contents inputted by the manipulation portion may be variously set. For example, a first manipulation unit may receive commands such as start, end, and scroll etc. and a second manipulation unit may receive commands such as intensity adjustment of sound outputted from the acoustic output module 152 and conversion into a touch reorganization mode of the display unit 151, etc.

The display unit 151 may display various kinds of the visual information. The information may be, for example, displayed in various forms of letters, figures, signs, graphics, icons, and etc. These are fixedly arranged to be displayed in preferably a keypad form so that the user may input corresponding information by selecting and touching a desired character. This is referred to as a “virtual keypad”.

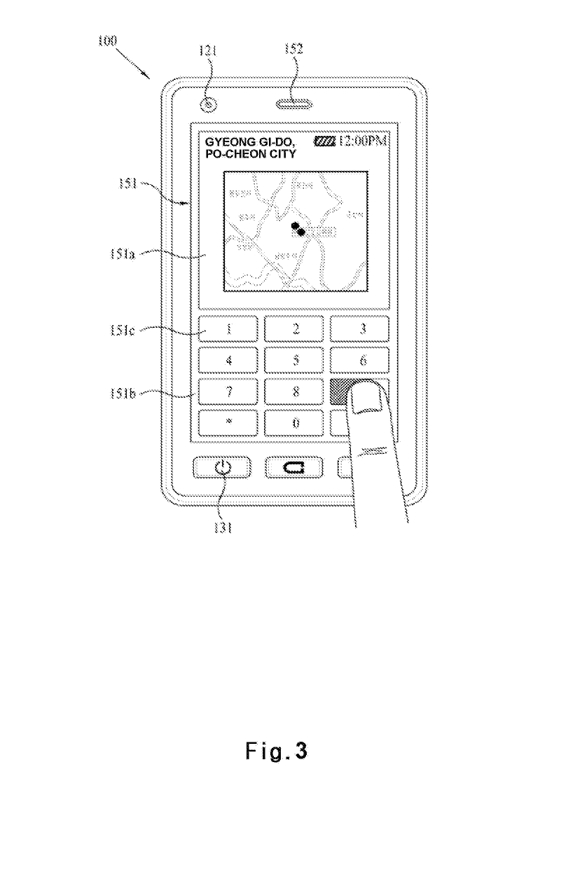

FIG. 3 shows a process of inputting information by a user through touch input applied to the visual keypad provided on a front screen of the mobile device. The display unit 151 operates as the whole area or as a plurality of divided areas. In the latter case, the plurality of divided areas are configured to operate to be involved with each other. For example, at each of the upper and lower portions of the display unit 151, an output window 151a and an input window 151b are arranged, the visual keypad 151c in which figures for entering the address/house number are displayed, is outputted. When the visual keypad 151c is touched, the figures, etc. corresponding to the touched point are displayed at one side area of the output window 151a. In addition, the touch pad implemented in a layered structure with the display unit 151 may recognize a touch input by scrolling and perform processing corresponding to the recognized touch input.

The user may move an entity (such as cursor or pointer located on an icon, etc.) displayed on the display unit 151 by scrolling the touch pad on the display unit 151. In addition, when the user moves her or his finger or fingers moves across the touch pad on the display unit 151, the course according to movement of the finger is visually displayed on the display unit 151. This is usefully in editing an image being displayed on the display unit 151. The display unit 151 shown in FIG. 3 may be implemented with the touch screen provided with the above-described function.

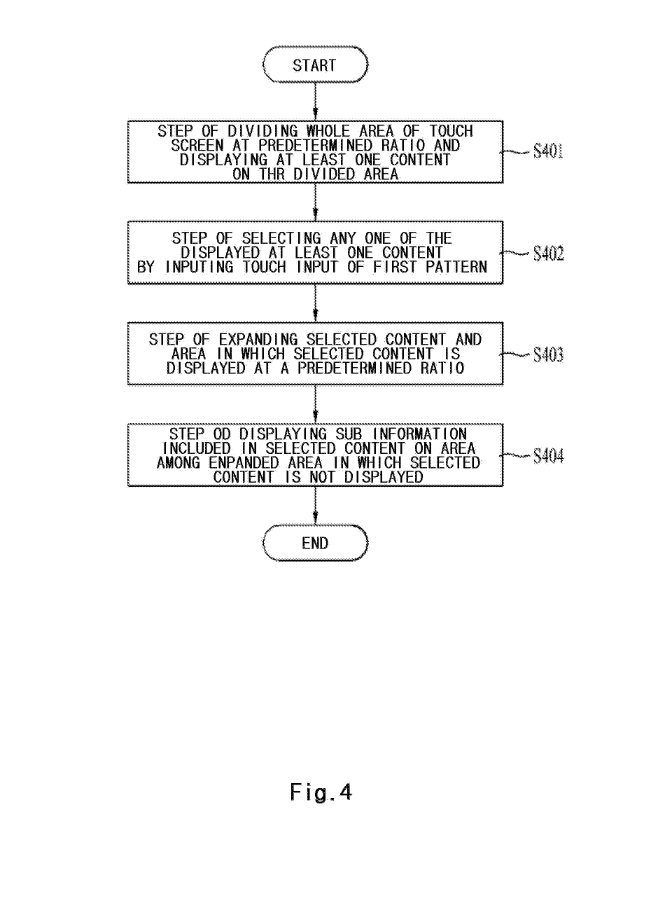

Hereinafter, an operation of the mobile device having the above-described configuration will be described with reference to the flow chart of FIG. 4. Meanwhile, graphics of an arrow or finger shape for pointing out a specific object or selecting a menu in the display unit 151 is referred to as the pointer or cursor. However, the pointer is often used as a finger or a stylus pen for touch operation. Accordingly, to clearly distinguish the pointer and the graphics in the exemplary embodiment of the inventive concept, the graphics displayed on the display unit 151 is referred to as the cursor, and the physical means for example a finger, a stylus pen, which can perform touch, proximity touch or gesture, is referred to as the pointer.

FIG. 4 is a flow chart explaining an operation of the mobile device provided with a contents control function for optimizing screen output according to an exemplary of the present invention. When the user turns on a power button (not shown) provided in the user input unit 130 of the mobile device 100, the control unit 180 outputs an initial screen allowing the user to select various multimedia functions, on a screen of the display unit 151 including the touch screen on the basis of the data stored in the memory 160.

At this time, if necessary, the control unit 180 may be configured to read the information to be displayed on the screen from the memory 160, divide the read information into representative information to be displayed on a first screen and sub information to be displayed on a second screen, and store the divided information in the content division storage unit 140. Alternatively, the control unit 180 may be configured to directly access the information to be displayed on the screen from the memory 160 without process of the special division storage.

The control unit 180 divides the whole area of the touch screen into a predetermined ratio, and at least one content is displayed in the divided area (S401). The ratio for dividing the touch screen or kinds of the contents to be displayed on each divided area may be set at a time of manufacturing the mobile device or may be arbitrarily designated by the user.

As described above, since the plurality of contents are simultaneously displayed on one screen, the plurality of sub information included in each of the contents can't be displayed on the one screen, the representative information, which can convey minimum information of the plurality of sub information, is exhibited in a corresponding area with the contents. For example, in the case of navigation content, a current location of the user and a route to a destination may be displayed as the representative information. In the case of news content, headline information of an article may be displayed as the representative information. In the case of weather content, a current external temperature and weather may be displayed as the representative information.

When the at least one content is displayed on the divided area, any one of the displayed contents may be selected by the touch input of the previously set pattern (S402). The touch input of the previously set pattern may be a long touch, a proximity touch, a long proximity touch, a double touch, etc. In addition, it may mean an input in which under a state that a first point and a second point on the contents are multi-touched, a distance between the first and second points exceeds a predetermined distance. This will be described later.

The above-described example is simply illustrative, but the present invention is not limited thereto. Hereinafter, it is assumed that the touch input for expanding a selected content is referred to as a touch of a first pattern to distinguish the touch input from a general touch input,

When any one content is selected as the touch input of the first pattern, the control unit 180 expands the selected content and an area in which the selected content is to be displayed at a preset ratio and the expanded content and area is displayed (S403). Subsequently, the control unit 180 displays sub information of the content selected by the user in an empty space of the expanded area, in which the contents are not included (S404). That is, by the above exemplary embodiment, the user can be provided with detailed sub information related to the selected information with the expanded image of the content selected by the user only by a simple touch input.

Even though the exemplary embodiment of the present invention describes that the content selected by the user and the area in which the content is displayed are expanded together, this is only one example, and it may be implemented that only the area in which the content selected is displayed is expanded. In addition, the expansion ratio may be set when the mobile device is manufactured or may be arbitrarily designated by the user.

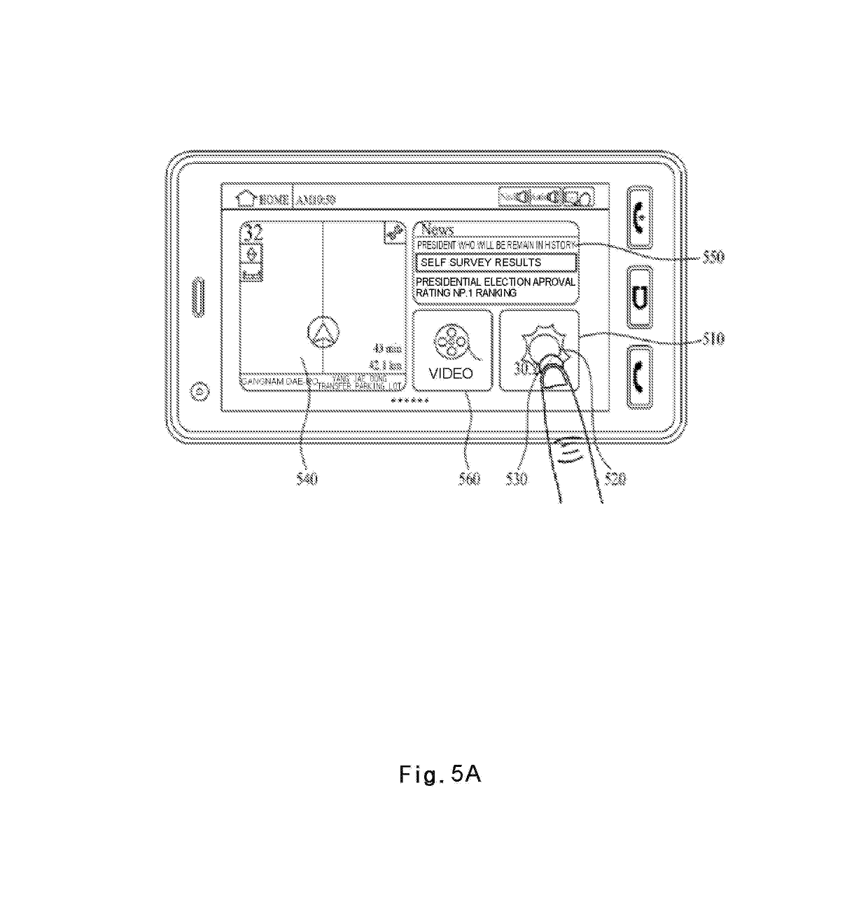

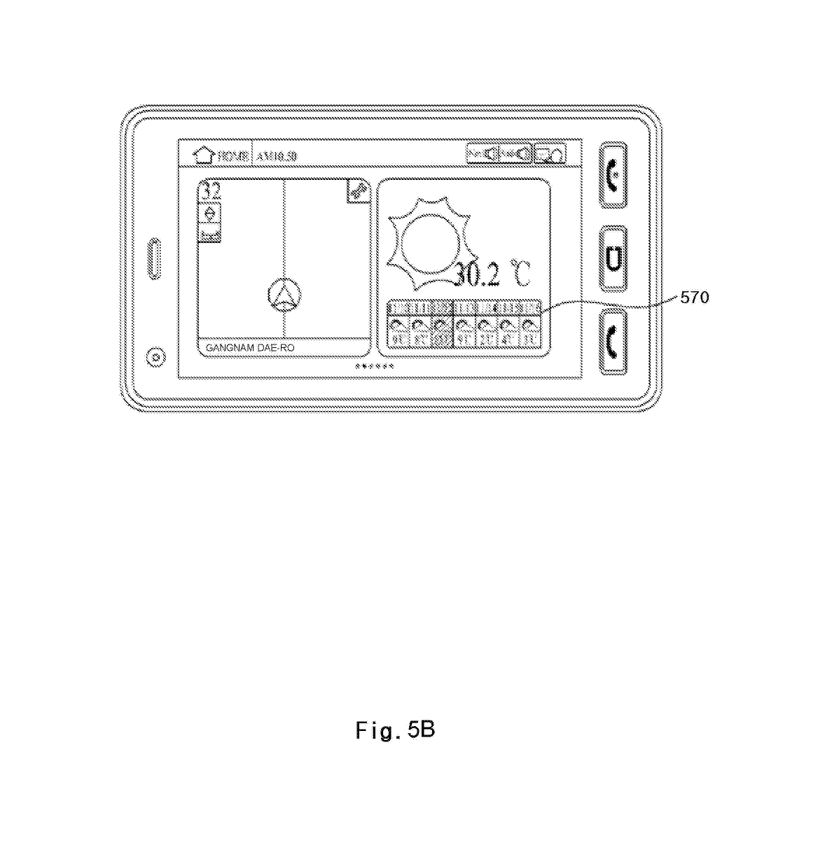

Hereinafter, a process in which a user expands the specific content and confirms the sub information through the expanded area will be described with reference to illustrative drawings. In an operation illustrated in FIGS. 5A and 5B, it is assumed that the touch input of the first pattern is a long touch input, and the expansion ratio is 50% of the whole screen of the touch screen.

First, as shown in FIG. 5A, the screen of the mobile device is configured so that the whole area of the touch screen is divided into a predetermined ratio formation and display navigation content 540, news content 550, video content 560, and weather content 530 are all displayed in each of the divided areas respectively. Among the contents, when the user selects, for example, the weather content 530 using a long touch input, as shown in FIG. 5B, the area of weather content selected by the user and the content included therein are expanded by at least 50% and outputted on the display unit 151.

At this time, a plurality of pieces of detailed information included in the weather content, that is, sub information 570 are displayed with an extra space in the expanded area. As shown in FIG. 5B, the sub information may include weather, a temperature, and a visual effect.

The touch input of the first pattern may mean an input in which under a first point and a second point on the content are multi-touched, a distance between the first and the second points exceeds a predetermined distance.

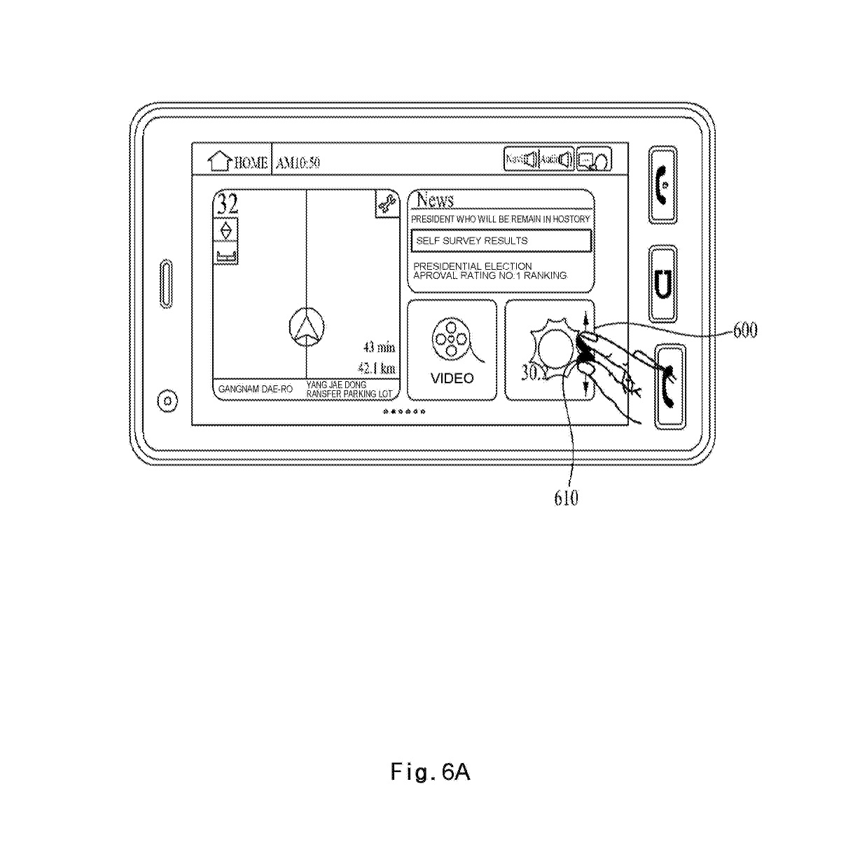

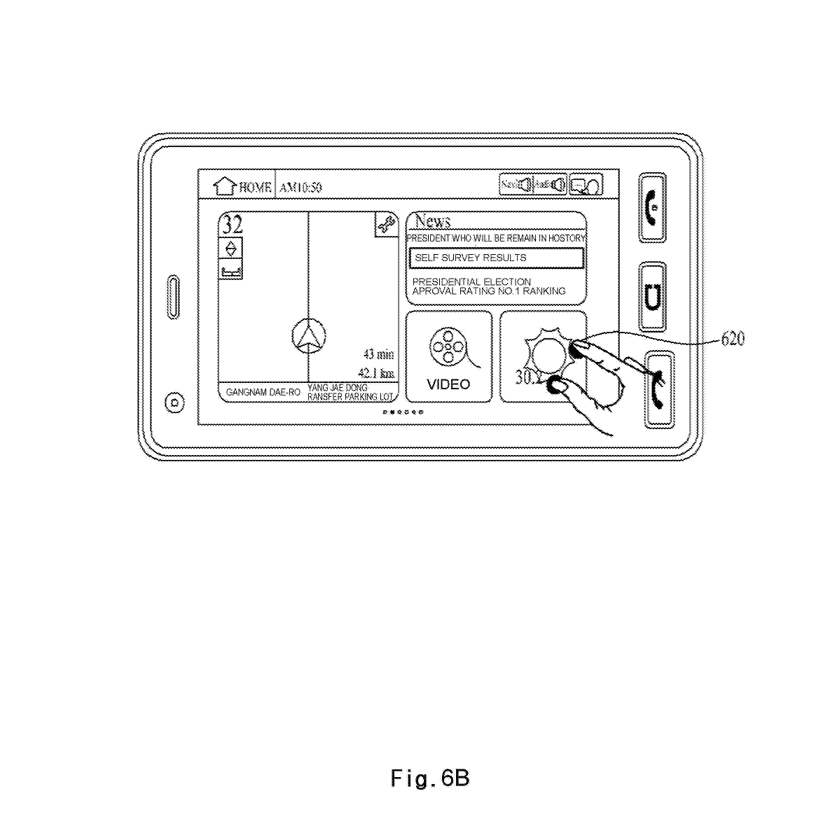

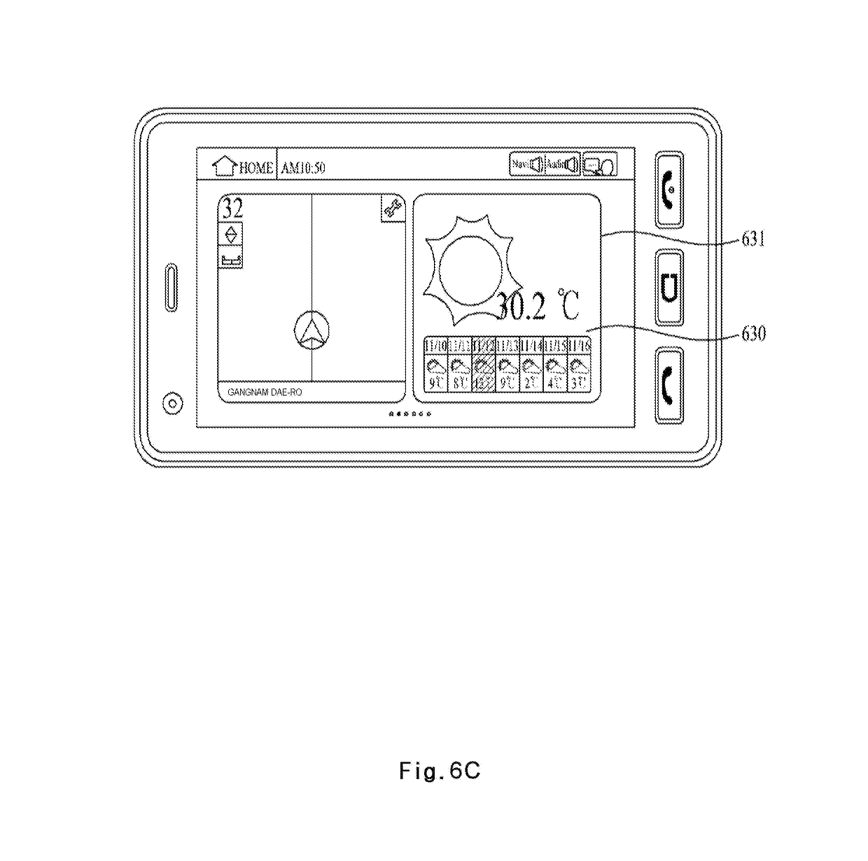

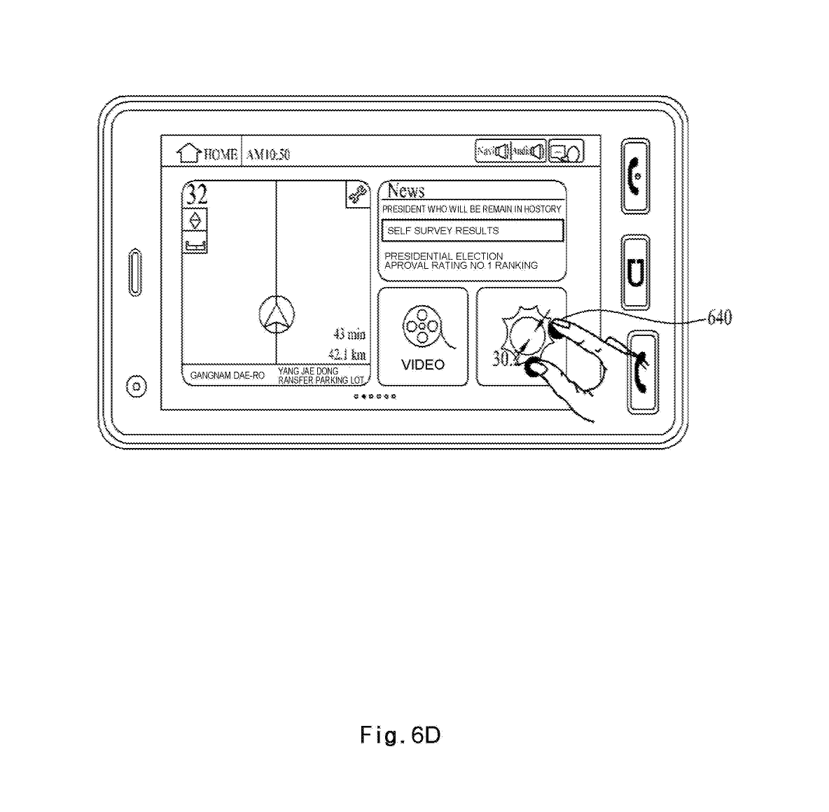

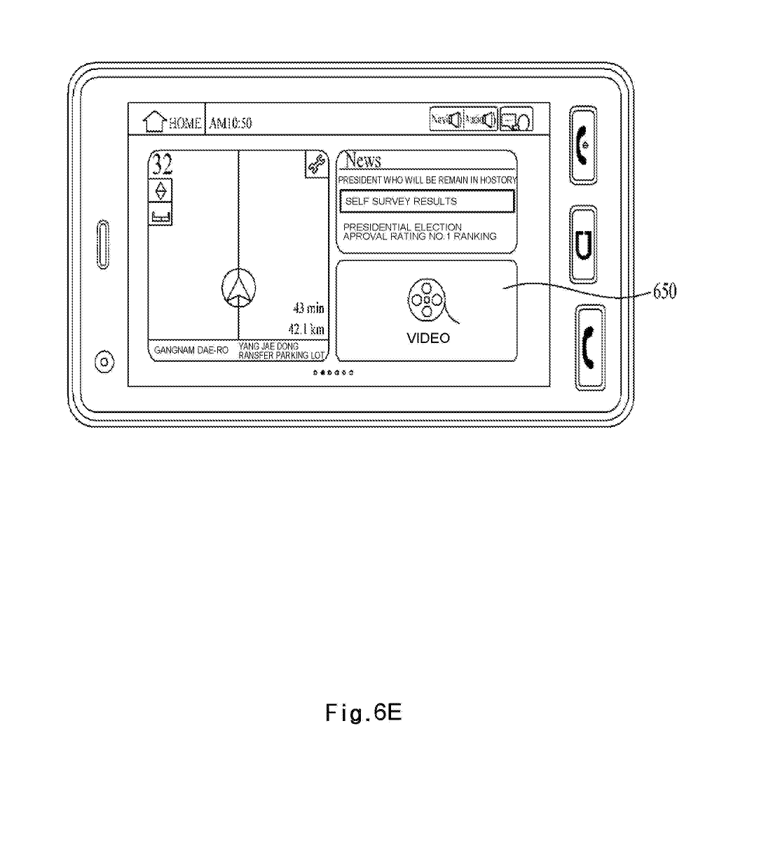

A process of inputting the touch input of the first pattern will be described in more detail with reference to FIGS. 6A to 6E. FIGS. 6A to 6E are views explaining processes of inputting multi-touch and expanding and downscaling a content through the multi-touch input according to an exemplary embodiment of the present invention.

First, as shown in FIG. 6A, under a state that a first point 600 and a second point 610 on the content are multi-touched by the user at the same time, as shown in FIG. 6B, when a distance between the two points is increasingly spread to be spaced apart at least a predetermined distance, the touch interaction module 182 of the control unit 180 recognizes this as the touch input of the first pattern. The predetermined distance may be previously designated during manufacturing the mobile device, or may be arbitrarily changed and set by the user.

When the touch input of the first pattern is detected, as shown in FIG. 6C, the control unit 180 expands a corresponding area 631 in which weather content 630 is expanded by at least 50% and displayed within the expanded area on the screen. At this time, the control unit 180 displays the detailed information included in the weather content, which is the sub information such as weather, a temperature, and a visual effect on an extra space in the expanded area on the basis of the data stored in the content division storage unit 140 or the memory 160.

The multi-touch may be also used when the user selects any one of the plurality of the contents displayed on the touch screen and erases the content by downscaling the selected content and the area in which the content is displayed. At this time, the multi-touch is implemented to recognize that the distance between the two points move towards each other up to at least the predetermined distance or less.

In other words, as shown in FIG. 6D, when the user touches (multi-touches) a first point and a second point on the weather content with his/her fingers at the same time, and the distance between the two points decreases by at least a predetermined distance, as shown in FIG. 6E, the control unit 180 recognizes this as the second pattern and downscales the area selected by the user and simultaneously deletes (erases) the content from the screen.

As described above, the exemplary embodiments provide the function that the user can easily expand any content of the plurality of contents displayed on the screen through the touch input of the first pattern or the touch of the second pattern to confirm the detailed information of the sub information, or the function that the user can easily narrow the distance between the two points the area and the content to delete (erase) the content. It is understood that the present invention is not limited to the exemplary embodiment, and various modifications are possible in the light of the above teachings. For example, it may be implemented that the sub information provided with the content expanded by the user is directly selected by the user.

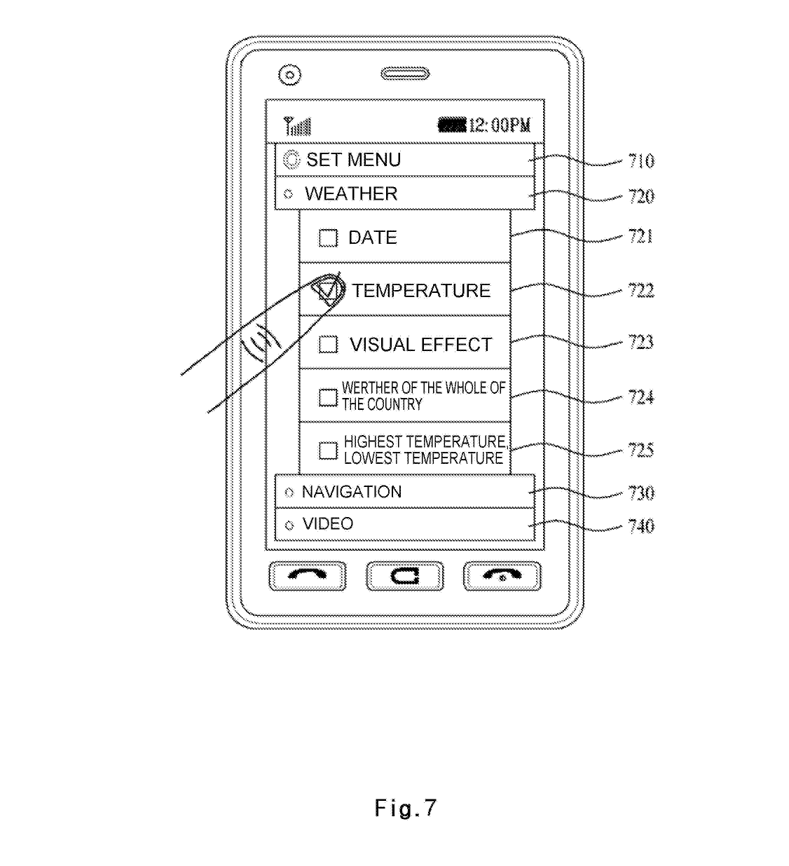

FIG. 7 is a view explaining a process of setting the sub information to be displayed in expanding a screen through a menu. As shown in FIG. 7, the contents included in the set menu 710 may include a weather content 720, a navigation content 730, a video content 740, and etc. When the user selects the weather content 720 of the contents, a list of the sub information is displayed on the screen in a drop down format. The sub information includes date information 721, temperature information 722, visual effect information 723, weather information of the whole country 724, highest/lowest temperature information 725.

Each of the sub information may include a check box, and the user may select an object to be displayed as the sub information by whether or not the check box is selected. When performing the expansion of the content by the user, if necessary, it may be set so that a predetermined visual effect is provided.

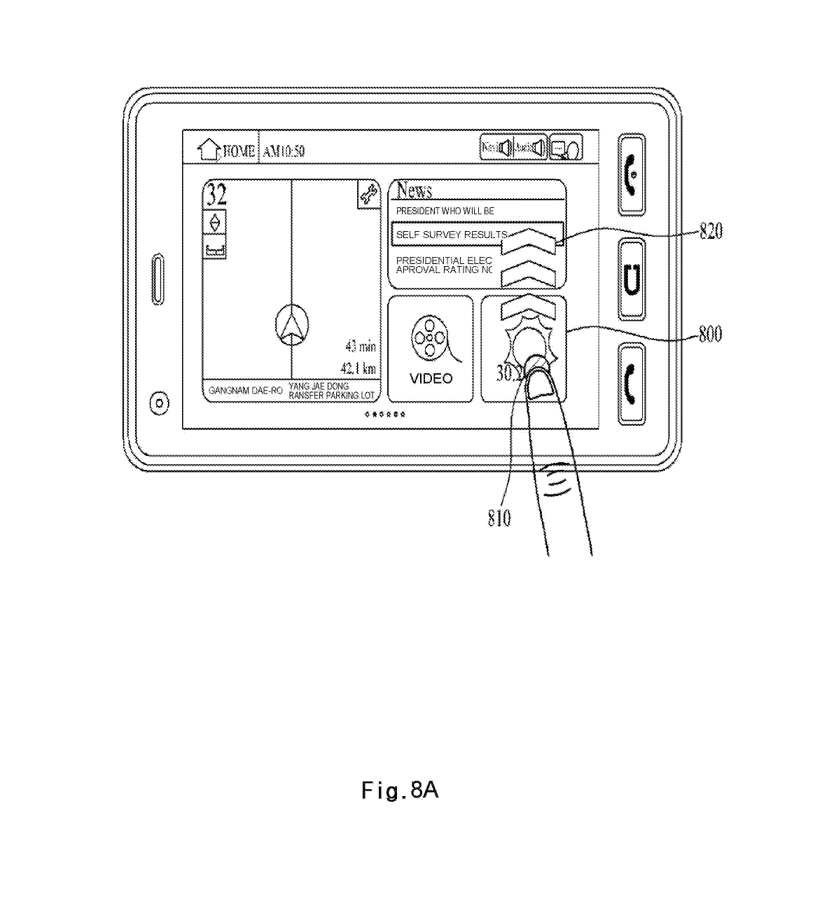

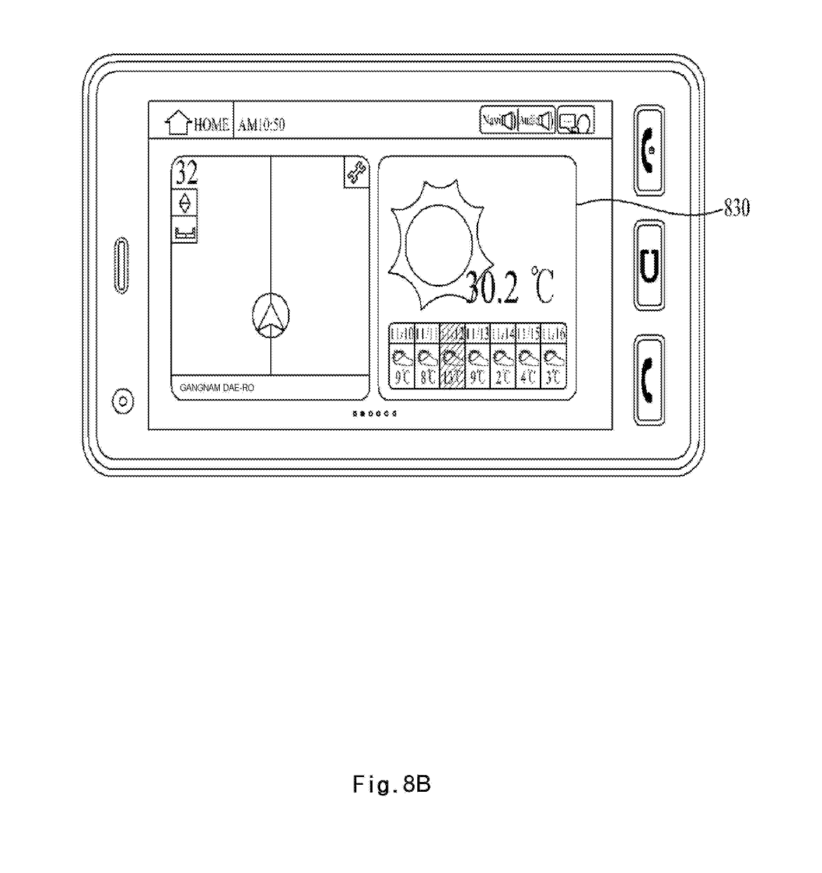

FIGS. 8A to 8B are views explaining a process of providing a visual effect. It is assumed that the touch input of the first pattern is a long touch input and the visual effect is indicated in a special indicator. When a weather content 800 is selected in the long touch input 810 by the user, as shown in FIG. 8A, the control unit 180 displays an indicator 820 as the visual effect in the weather content 800 which is the object to be expanded, and subsequently, as shown in FIG. 8B, the weather content 830 is expanded and displayed accordingly.

Therefore, the user can easily and efficiently confirm the content selected to be expanded by the user himself/herself through the indicator. Subsequently, various manners of the touch input to be implemented as the touch input of the second pattern will be described.

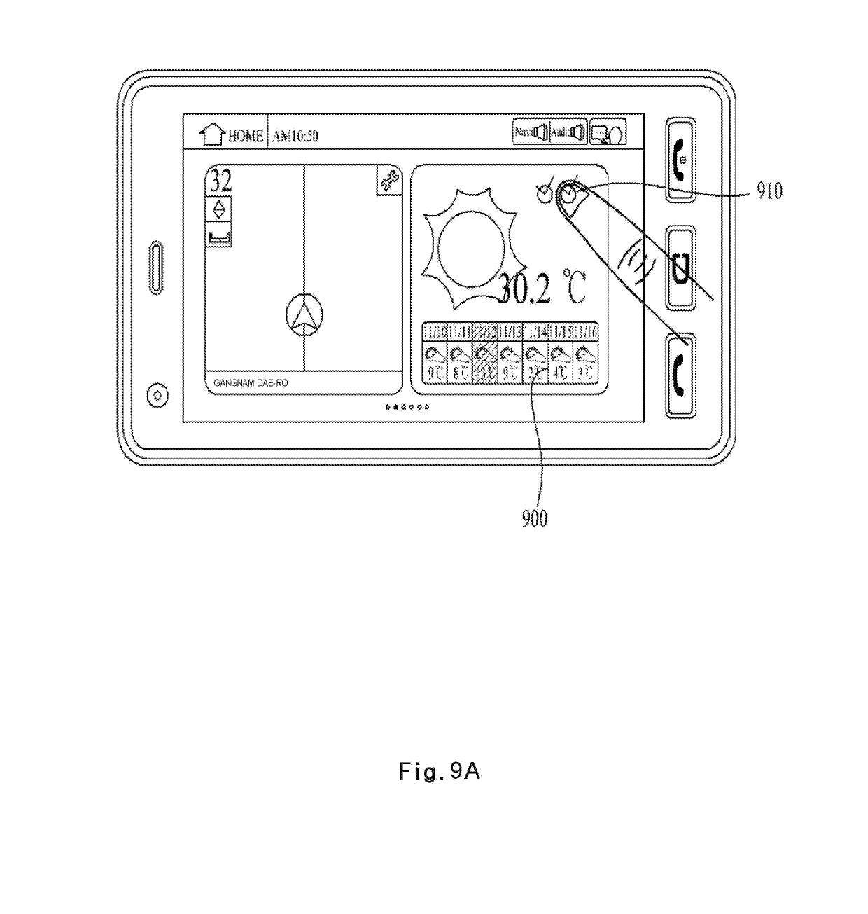

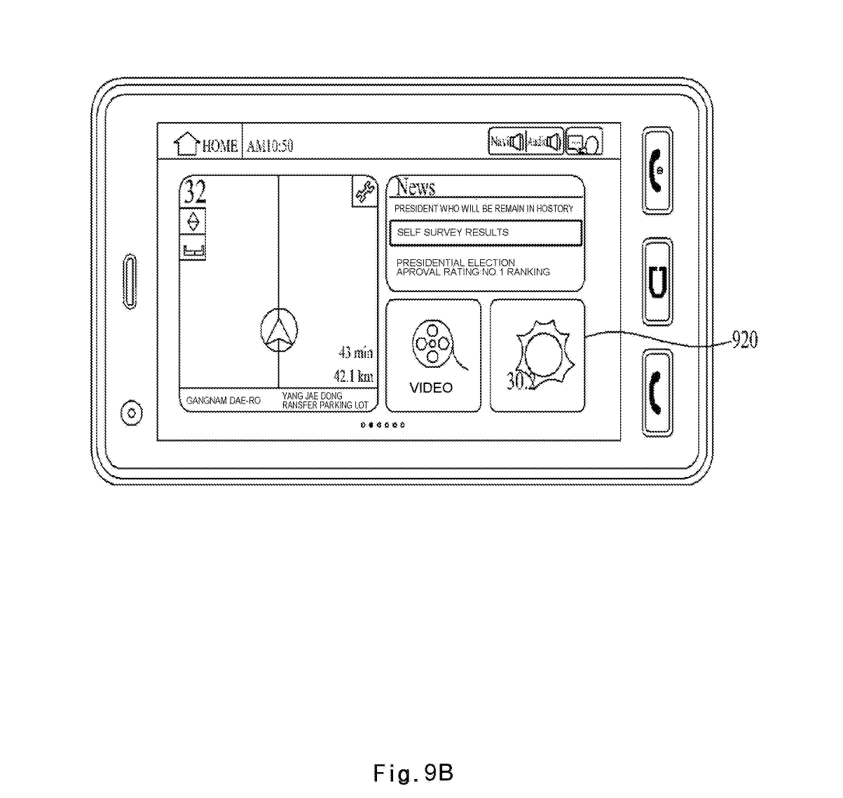

FIGS. 9A and 9B are views explaining an example for executing a touch input of a second pattern by a double touch input according to another exemplary embodiment of the present invention. As shown in FIG. 9A, when, for example, weather content including sub information 900 is expanded and displayed on a screen and a user double touches a predetermined area 910 of the touch screen, as shown in FIG. 9B, the expanded weather content is downscaled to the original ratio 920, and then the sub information disappears. That is, the user can easily convert the screen back to its original form by using double touch input as the touch input of the second pattern.

Meanwhile, even though the whole functions according to the exemplary embodiment of the present invention are implemented by adding the separate hardware, the functions may be implemented as a processor-readable code on a medium in which a program is recorded. That is, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A content control system for optimizing information on a display screen of a mobile device including a touch screen, the mobile device comprising:
a memory configured to store contents to be displayed on a touch screen as data;
a control unit configured to control an overall operation of the device according to a user's touch input through the touch screen; and
a touch interaction module configured to analyze the user's touch input through the touch screen and to recognize a control command corresponding to the user's touch input,
wherein when a touch input of a first pattern is recognized through the touch interaction module, content related to an area on the display to which the touch input is applied is expanded and outputted at a preset rate and detailed information associated with the content in that area is read and displayed simultaneously to display the expanded content on a screen.

2. The system of claim 1, wherein the memory is a content division storage unit in which sub information including detailed information on each of one or more contents output through the touch screen is divided into multiple steps as a hierarchical structure and managed accordingly.

3. The system of claim 1, wherein the touch interaction module is embodied in the control unit.

4. The system of claim 2, wherein, when the touch input of the first pattern is consecutively sensed through the touch interaction module, the control unit outputs the sub information of the hierarchical structure in step by step at each time of point that the touch input is sensed.

5. The system of claim 2, wherein, when a touch input of a second pattern is sensed through the touch interaction module, the control unit downscales and displays the content of a corresponding area at a predetermined ratio step by step and simultaneously erases sub information of a hierarchical structure on a screen at each time that the touch input of the second pattern is sensed.

6. A content control method for optimizing information on a display screen of a mobile device including a memory configured to store contents to be output through a touch screen as data and a control unit configured to control the device, the method comprising:
recognizing, by a control unit, a touch input of a first pattern input through the touch screen; and
expanding, by the control unit, content related to an area in which the touch input of the first pattern is input at a predetermined ratio and displaying the expanded content on a screen, and simultaneously reading detailed information of the content selected by the touch input of the first pattern from the memory and outputting the read detailed information.

7. The method of claim 6, wherein information of the content stored in the memory is implemented with a plurality of hierarchical structures having detailed contents step by step, and
wherein, when the touch input of the first pattern is consecutively sensed in the recognizing the touch input, the control unit reads sub information from the memory step by step and sequentially executes the expanding the content and outputting detailed information based on the read sub information at each time of point that the touch input of the first pattern is sensed.

8. The method of claim 7, wherein the recognizing the touch input further includes recognizing a touch input of a second pattern input through the touch screen, and
wherein, when the touch input of the second pattern is sensed while recognizing the touch input, the control unit downscales a content of a corresponding area by a predetermined ratio and outputs the downscaled content on the screen and simultaneously the control unit erases sub information of the content selected by the touch input of the second pattern step by step at each time of point that the touch input of the second pattern is sensed.

9. The method of claim 6, wherein the touch input of the first pattern is defined as an input type, in which when a first point and a second point on a content displayed on the touch screen are multi-touched, a distance between the first and second points is increased to exceed a predetermined distance.

10. The method of claim 8, wherein the touch input of the second pattern is defined as an input type, in which when a first point and a second point on a content displayed on the touch screen are multi-touched, a distance between the first and second points decreased to a predetermined distance.

11. The method of claim 8, wherein the touch input of the second pattern is implemented with any one selected from the group consisting of a long touch, a proximity touch, a long proximity touch, and a double touch.

12. A non-transitory computer readable medium containing program instructions executed by a processor or controller, the computer readable medium comprising:
program instructions that recognize a touch input of a first pattern input through a touch screen; and
program instructions that expand content related to an area in which the touch input of the first pattern is input at a predetermined ratio and displaying the expanded content on a screen, and simultaneously reading detailed information of the content selected by the touch input of the first pattern from a memory and outputting the read detailed information.

13. The non-transitory computer readable of claim 12, wherein information of the content stored in the memory is implemented with a plurality of hierarchical structures having detailed contents step by step, and
wherein, when the touch input of the first pattern is consecutively sensed in the recognizing the touch input, the control unit reads sub information from the memory step by step and sequentially executes the expanding the content and outputting detailed information based on the read sub information at each time of point that the touch input of the first pattern is sensed.

14. The non-transitory computer readable of claim 13, wherein the program instructions that recognize the touch input further includes program instructions that recognize a touch input of a second pattern input through the touch screen, and
wherein, when the touch input of the second pattern is sensed while recognizing the touch input, the control unit downscales a content of a corresponding area by a predetermined ratio and outputs the downscaled content on the screen and simultaneously the control unit erases sub information of the content selected by the touch input of the second pattern step by step at each time of point that the touch input of the second pattern is sensed.

15. The non-transitory computer readable of claim 12, wherein the touch input of the first pattern is defined as an input type, in which when a first point and a second point on a content displayed on the touch screen are multi-touched, a distance between the first and second points is increased to exceed a predetermined distance.

16. The non-transitory computer readable of claim 14, wherein the touch input of the second pattern is defined as an input type, in which when a first point and a second point on a content displayed on the touch screen are multi-touched, a distance between the first and second points decreased to a predetermined distance.

17. The non-transitory computer readable of claim 14, wherein the touch input of the second pattern is implemented with any one selected from the group consisting of a long touch, a proximity touch, a long proximity touch, and a double touch.
